(19) United States
(12) Patent Application Publication
(10) Pub. No.: US 2024/0220295 A1
(43) Pub. Date: Jul. 4, 2024

(54) EVENT INTERCEPTION CONTROL BY A TRUSTED LAYER OF A VIRTUAL MACHINE

(71) Applicant: ADVANCED MICRO DEVICES, INC., Santa Clara, CA (US)

(72) Inventors: David Kaplan, Austin, TX (US); Jelena Ilic, Austin, TX (US)

(21) Appl. No.: 18/090,604

(22) Filed: Dec. 29, 2022

(51) Int. Cl. G06F 9/455

(52) U.S. Cl. CPC G06F 9/45558; G06F 2009/45587

(57) ABSTRACT

A processor supports programmable control, by a trusted layer of a virtual machine (VM), of the interception of events at the processor. The trusted layer of the VM programs security control information (e.g., a control register or other control structure) that designates particular events that are to be intercepted when triggered by another layer of the VM. In response to detecting a designated event, system hardware intercepts the event, rather than executing the event. The VM is thereby able to protect confidential information and program behavior without relying on a hypervisor, thus improving overall system security.

### BACKGROUND

In a confidential computing environment, a processing system (e.g., a server) executes multiple software programs, such as virtual machines and a virtual machine manager (e.g., a hypervisor), wherein different software programs are owned by different entities. For example, in some confidential computing environments, different virtual machines executed by the environment are owned by different companies. A virtual machine manager (e.g., a hypervisor) controls the scheduling of the different virtual machines for execution and provides an interface between the virtual machines and the server hardware, so that each virtual machine (VM) is able to operate as if that VM were executing on its own dedicated hardware.

Because the different VMs are often owned by different entities, some confidential computing systems support security features that prevent one VM from accessing the data or other information associated with another VM. These security features are conventionally implemented by the virtual machine manager. However, this approach presents its own potential security issues, including allowing a malicious virtual machine manager to access confidential information of a given VM.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system that supports control of event interception by a trusted layer of a virtual machine (VM) in accordance with some embodiments.

FIG. 2 is a block diagram illustrating an example of the VM of FIG. 1 having different layers, associated with different levels of trust, in accordance with some embodiments.

FIG. 3 is a block diagram illustrating an example of the processing system of FIG. 1 intercepting the setting or modification of a control register based on control information programmed by a trusted layer of a VM in accordance with some embodiments.

FIG. 4 is a block diagram illustrating an example of the processing system of FIG. 1 intercepting and allowing programming of a control register from different untrusted layers of a VM based on control information set by a trusted layer of the VM in accordance with some embodiments.

FIG. 5 is a block diagram illustrating an example of the processing system of FIG. 1 intercepting and allowing programming of different control registers by an untrusted layer of a VM based on control information programmed by a trusted layer of a VM in accordance with some embodiments.

FIG. 6 is a flow diagram illustrating a method of controlling of event interception by a trusted layer of a VM in accordance with some embodiments.

### DETAILED DESCRIPTION

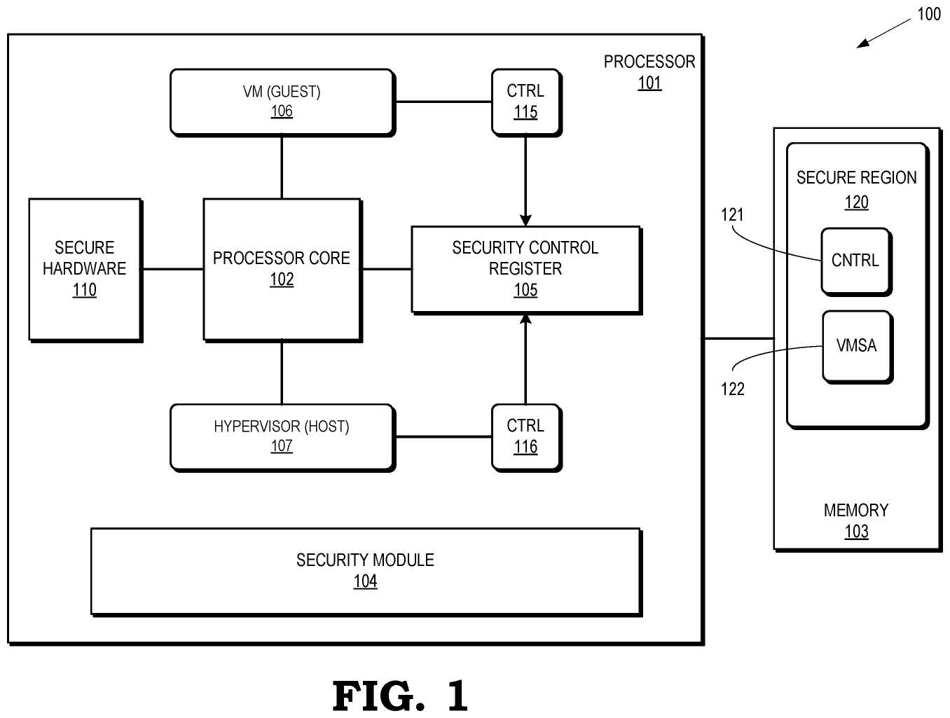

FIGS. 1-6 illustrate techniques for implementing programmable control, by a trusted layer of a virtual machine (VM), of the interception of events at a processing system. The trusted layer of the VM programs security control information (e.g., a control register or other control structure) that designates particular events that are to be intercepted when triggered by another layer of the VM. In response to detecting a designated event, system hardware intercepts the event, rather than executing the event. The VM is thereby able to protect confidential information and program behavior without relying on a hypervisor, thereby improving overall system security.

To illustrate via an example, in some cases a particular system event, such as the setting or modification of data stored at a control register (that is, programming the control register), renders sensitive VM data vulnerable to unauthorized access. For example, in some cases a control register indicates whether memory paging is enabled or disabled for a VM and disabling memory paging renders the VM data vulnerable to unauthorized access. To prevent this vulnerability, system hardware is configured to intercept designated events, such as programming of the memory paging control register, based on security control information. Thus, in response to detecting an event designated by the security control information, the system hardware intercepts the event, and prevents execution of any operations requested by the event, such as execution of instructions or writing to any registers, thereby preventing unauthorized access to the sensitive VM data, thereby preventing unauthorized access to the sensitive VM data.

In some systems, the security control information is managed by a VM manager, such as a hypervisor. In such systems, a VM can request the hypervisor to designate events for interception, and in response the hypervisor sets the security control information. However, this approach is vulnerable to a malicious hypervisor. For example, a malicious hypervisor could ignore the VM requests, and thereby prevent interception of designated events. Using the techniques herein, the security control information is managed, at least in part, by a trusted layer of the VM itself. Thus, the trusted layer of the VM directly programs the security control information, and thereby itself controls which events are intercepted by the system hardware.

To illustrate further, in some embodiments a VM includes multiple layers, wherein each layer is assigned a different address space in a virtual address space associated with the VM. A security module (e.g., a security co-processor) of the processing system performs a specified security process to designate one of the multiple layers as a trusted layer of the VM. In some embodiments, the trusted layer of the VM manages the security operations for the VM while other, less trusted layers, perform other operations, such as execution of an operating system or other software. To protect the security control information, the system hardware only executes instructions to program (e.g., modify) the security control information if those instructions are issued by the trusted layer of the VM—that is, if the instructions are issued from the address space corresponding to the trusted layer. This allows the trusted layer of the VM to control interception of events triggered by other layers of the VM, such as a particular event triggered by an application associated with a less-trusted layer of the VM.

FIG. 1 illustrates a processing system 100 that supports control of event interception by a trusted layer of a VM in accordance with some embodiments. The processing system 100 is generally configured to execute sets of instructions (e.g., computer programs) to carry out tasks on behalf of an electronic device. Accordingly, in different embodiments the processing system 100 is part of any of a variety of electronic devices. For purposes of description, it is assumed that the processing system 100 is part of an electronic device that implements a confidential computing environment, such as a server. However, in other embodiments, the processing system 100 is part of a desktop computer, laptop computer, tablet, game console, and the like.

To implement the confidential computing environment, and to execute the sets of instructions, the processing system 100 includes a processor 101 and a memory 103. In some embodiments, the processor 101 is a general-purpose processor, such as a central processing unit (CPU) including hardware structures configured to retrieve and execute the sets of instructions. The memory 103 includes one or more memory devices configured to store and retrieve data based on commands (e.g., store and load commands) received from the processor 101. Accordingly, in different embodiments the memory 103 is random access memory (RAM), non-volatile memory (NVM), hard disc memory, and the like, or any combination thereof.

To execute the sets of instructions, the processor 101 includes a processor core 102, a security module 104, a security control register 105, and secure hardware 110. It will be appreciated that in some embodiments the processor 101 includes additional hardware to execute instructions, and to execute operations based on those instructions, such as additional processor cores, additional processing units (e.g., one or more graphics processing units), one or more controllers (e.g., memory controllers and input/output controllers), and the like.

The processor core 102 includes one or more instruction pipelines including a plurality of stages to execute instructions in a pipelined fashion. Thus, for example, in some embodiments an instruction pipeline of the processor core 102 includes a fetch stage, a decode stage, a dispatch stage, one or more execution stages (with one or more corresponding execution units), a retire stage, and the like. The processor core 102 also includes, or has access to, memory structures and other hardware (not explicitly illustrated at FIG. 1) that support execution of instructions. For example, in some embodiments the processor core 102 includes or has access to one or more cache structures to store data used for execution of the instructions.

In some embodiments, the processor 101 is a simultaneous multithreading (SMT) processor. Accordingly, in some embodiments the processor core 102, as well as other hardware of the processor 101, is configured to concurrently execute program threads (referred to herein simply as “threads”) by sharing hardware resources between the concurrently executing threads. For example, in at least some embodiments, different threads concurrently execute at a given stage of an instruction pipeline of the processor core 102 by sharing the hardware resources of that pipeline stage. As another example, in some embodiments different threads concurrently execute at the processor 101 by sharing portions of a cache of the processor core 102. For purposes of description, when two or more threads are concurrently executing at the processor 101, the processor 101 is referred to as being in an SMT mode.

The security module 104 is a set of hardware structures generally configured to create, monitor and maintain a security environment for the processor 101. For example, in at least some embodiments the security module 104 is configured to manage the boot process for the processor 101, initialize security related mechanisms for the processor 101, register different layers of a VM with different levels of trust, and monitor the processing system 100 for suspicious activity or events and implement an appropriate response. In some embodiments the security module 104 includes a microcontroller, a cryptographic coprocessor (CCP) to encrypt and decrypt data, local memory and local registers to store, for example, cryptographic keys, and includes interfaces to interact with the memory 103, the I/O controller of the processor 101, and configuration registers of the processor 101. In some embodiments, the security module 104 includes Environment Management Control hardware that environmental and security checking to ensure that the processor 101 is operating according to specified security parameters.

The secure hardware 110 includes hardware, and associated microcode, of the processor 101 that supports the processor core 102 in executing instructions but is not accessible or modifiable by software executing at the processor core 102. For example, in some embodiments the secure hardware 110 includes hardware that implements finite state machines, hardwired control unit operations, and other hardware that carries out at least some operations generated by the processor core 102, based on the executing instructions. However, the operations of the secure hardware 110 are not accessible or modifiable by the executing software, the secure hardware 110 is able to provide security features in the course of executing operations as described further herein, and without those features being subject to unauthorized modification.

As noted above, the processing system 100 is generally configured to implement a confidential computing environment, and in particular to execute a plurality of virtual machines (VMs) (e.g., VM 106), also referred to as guests, and a hypervisor 107, also referred to as a host, to manage execution of the plurality of VMs. Because the different VMs, and at least in some cases the hypervisor 107, are owned by different entities, the processing system 100 implements security features to protect the data of a given VM from access by other software, such as by another VM or by the hypervisor 107. For example, the processing system 100 implements data security for the VMs by implementing a secure region 120 of the memory 103 that stores encrypted data. In particular, the processor 101 is configured to encrypt specified data for each VM according to a corresponding private cryptographic key, and to store the encrypted data at the secure region 120. Because the data is encrypted, the data for one VM is protected from unauthorized access by other VMs and by the hypervisor 107. In at least some embodiments, cryptographic keys for the VMs are managed by the security module 104, and data encryption and decryption for the VMs is executed by a dedicated hardware encryption/decryption module (not shown) at a memory controller (not shown) of the processor 101.

To further illustrate via an example, in the depicted embodiment the secure region 120 stores two blocks of data for the VM 106: control information 121 and a virtual machine storage area (VMSA) 122. The control information 121 stores control information for the VM 106, while the VMSA stores data for the software programs executed by the VM 106. In response to a request to store information by the VM 106 (e.g., in response to a VM exit), the processor 101 encrypts the information, using the cryptographic key associated with the VM 106, and stores the information at the corresponding block (either the control information 121 or the VMSA 122). Similarly, in response to a request to retrieve information from the secure region 120 by the VM 106, the processor 101 retrieves the requested information from the corresponding block, decrypts the information using the cryptographic key associated with the VM 106, and provides the decrypted information to the VM 106.

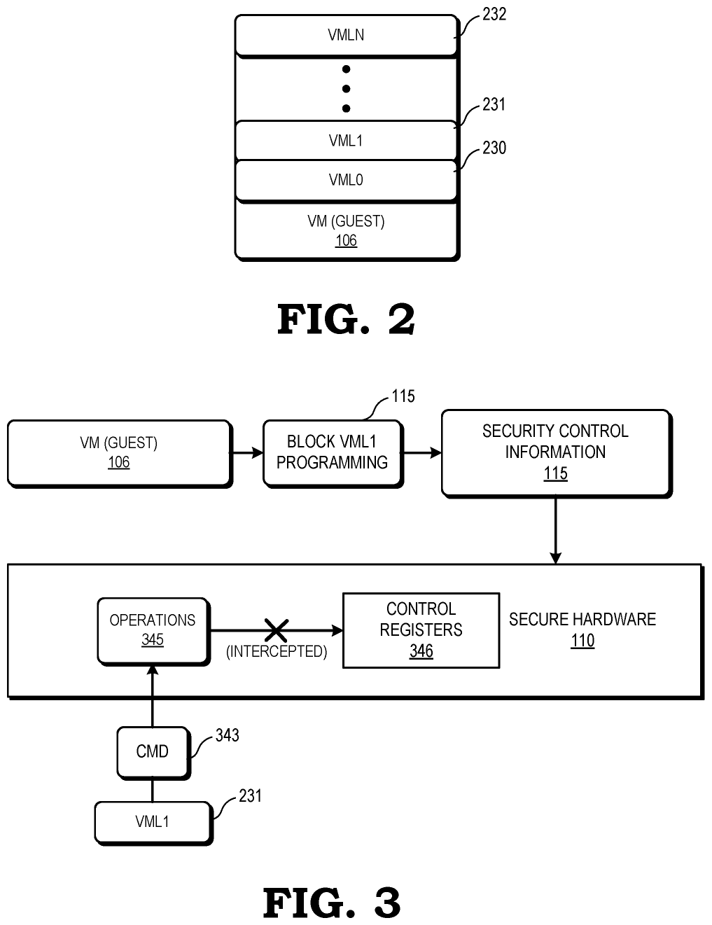

To provide further security for VM data, the security module 104 is configured to associate different layers of the VM 106 with different levels of trust. FIG. 2 depicts an example of the VM 106 with different layers in accordance with some embodiments. In the depicted example, the VM 106 includes N layers (where N is an integer), including a layer 230, a layer 231, and additional layers through Nth layer 232. In some embodiments, each of the layers 230-232 corresponds to a different address space. For example, in some embodiments the VM 106 employs a virtual address space to designate the memory locations for each software instruction, and each data operand, for the different software programs and operations of the VM 106. Each of the layers 230-232 corresponds to a different portion of the virtual address space of the VM 106. Accordingly, the virtual address space for layer 231 corresponds to the virtual address space of the instructions and data operands for the programs and operations in layer 231.

Returning to FIG. 1, in at least some embodiments the layers 230-232 are assigned different levels of trust by the security module 104. For example, in some embodiments, before the VM 106 is permitted to be executed at the processing system 100, the VM 106 undergoes a provisioning process. During the provisioning process, the VM 106 provides authentication information, such as one or more security keys, to the security module 104 to register the layers 230-232 at different levels of trust. In response to verifying the authentication information, the security module 104 assigns each of the layers 230-232 the requested level of trust.

In at least some embodiments, the level of trust for the layers 230-232 is enforced by the secure hardware 110. For example, in some cases, one or more specified operations, such as modification of page tables for the VM 106, are only permitted to be performed by the layers 230-232 having a threshold level of trust. In response to an instruction to perform the specified operation, the secure hardware 110 identifies, based on the virtual address of the instruction, which of the layers 230-232 issued the instruction. If the identified layer has the requisite level of trust, the secure hardware executes the instructions. Otherwise, the secure hardware 110 does not execute the instruction. In this way, the secure hardware 110 ensures that instructions are executed only by those layers of the VM 106 that have a specified level of trust. For purposes of description, it is assumed that the layer 230 of the VM 106 has been registered by the security module 104 to have the highest level of trust, the layer 231 has been registered to have a lower level of trust, and so on, with the layer 232 having the lowest level of trust.

To further enhance security of the processing system 100, the secure hardware 110 is configured to intercept designated events, such as one or more designated commands, exceptions, or instructions, based on security control information stored at the security control register 105. For example, in some embodiments the security control information at the security control register 105 designates a particular command to program a particular control register to be intercepted, because it is expected that allowing execution of the command could expose secure information at the processing system 100. The secure hardware 110 is configured, in response to the command, to identify whether the security control information indicates the command is to be intercepted. If not, the secure hardware 110 proceeds to execute the command and thus to program the control register. If the security control information indicates that the command is to be intercepted, the secure hardware 110 does not execute the command and, in some embodiments, notifies the security module 104 that the command has been intercepted. In response, the security module 104 takes remedial action, such as instructing the processor 101 to stop execution of software, sending an error message to the processor 101 or to another processing system (not shown), and the like.

The security control register 105 is a programmable register. Accordingly, by storing particular values at the security control register 105 (also referred to as programming the security control register 105), software is able to designate particular events for interception by the secure hardware 110. In some embodiments, the security control register 105 is programmable both by the hypervisor 107 and by a trusted layer (e.g., layer 230) of the VM 106. In the depicted example of FIG. 1, the hypervisor 107 programs the security control register 105 by storing control information 116 at the security control register 105. Similarly, the trusted layer 230 of the VM 106 programs the security control register 105 by storing security control information 115 at the security control register 105. Thus, in some embodiments, the events to be intercepted by the secure hardware 110 are designated by the trusted layer 230, via programming the security control register 105 with the control information 116. This allows the creator of the VM 106 the flexibility to protect secure information from potential security breaches resulting from particular events (e.g., particular instructions, commands, exceptions, register writes, and the like). Further, the VM 106 is able to program the security control register 105 directly, rather than via a request to the hypervisor 107, thus further enhancing the security of the VM 106.

To illustrate further via an example, in some embodiments the layer 231 is able to issue a command, designated WRITECR0, to write a value to a register designated CR0. The security control register 105 includes one or more bits that indicate whether the WRITECR0 command is allowed to be executed, and these one or more bits are programmable by the trusted layer 230, as well as by the hypervisor 107. In response to the layer 231 issuing the WRITECR0 command, the secure hardware 110 checks the security control register 105, and in particular the bits corresponding to the WRITECR0 command. If the security control register 105 indicates that WRITECR0 command is allowed, the secure hardware 110 executes the command and writes the value indicated by the command to the CR0 register. If the security control register 105 indicates that the WRITECR0 command is not allowed, the secure hardware 110 intercepts the command, and does not write the value to the CR0 register. In some embodiments, in response to intercepting the CR0 command, the secure hardware 110 triggers the executing VM to exit (e.g., triggers a VMEXIT). In response to the VM exiting, the hypervisor 107 invokes the trusted layer 230 of the VM. Thus, interception of the WRITECR0 command is ensured and the layer 231 is prevented from invoking a potentially dangerous operation.

An example of the VM 106 programming the security control register 105 to intercept a designated event is illustrated at FIG. 3 in accordance with some embodiments. In the depicted example, the trusted layer 230 of the VM 106 programs the security control register 105 with the security control information 115. For the example of FIG. 3, the security control information 115 designates to be intercepted commands to program one of a set of control registers 346 that are triggered by the layer 231 of the VM 106. It will be appreciated that, for purposes of the example of FIG. 3, it is assumed that the control information designates all such commands triggered by the layer 231 to be intercepted. However, in other embodiments, the security control information 115 designates a command of a particular type (e.g., a command to program a particular one of the control registers 346), or one or more commands of different corresponding types (e.g., commands to program different selected ones of the control registers 346) to be intercepted.

After the security control information 115 has been stored at the security control register 105, the layer 231 of the VM 106 issues a command 343, requesting execution of operations 345 to program one of the control registers 346 with a particular value. However, based on the security control information 115 at the security control register 105, the secure hardware 110 intercepts the command, and in particular prevents execution of the operations 345 so that the command 343 is not executed and the data stored at the control registers 346 is not modified. Thus, in the example of FIG. 3, the trusted layer 230 prevents execution of operations that could potentially expose secure data of the VM 106 to unauthorized access.

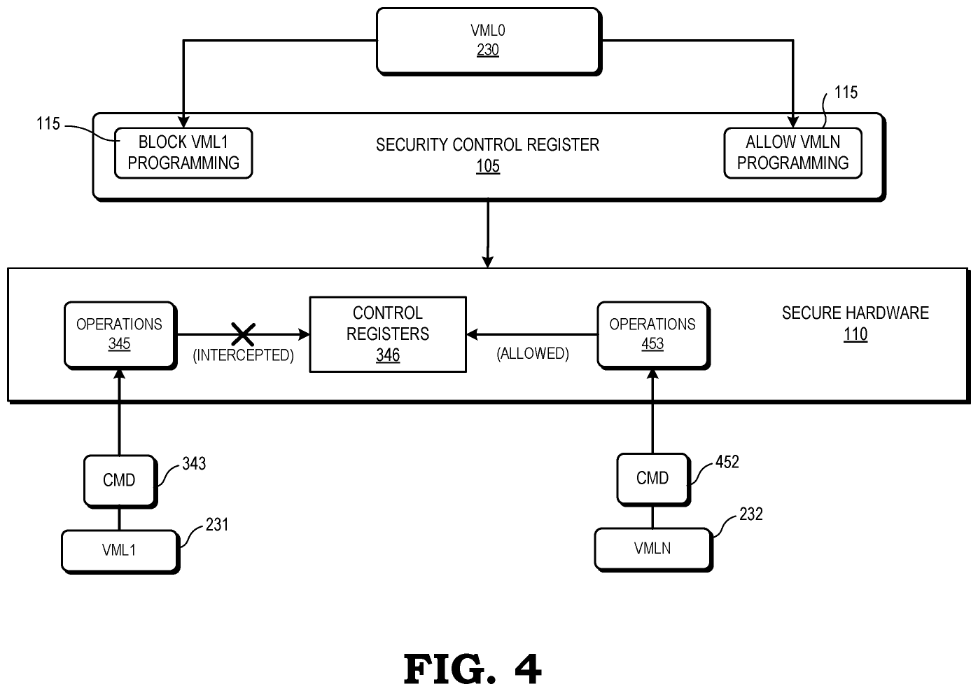

In some embodiments, the trusted layer 230 permits events (e.g., a particular command to program a control register) triggered by a particular layer of the VM 106 and prohibits the same events (e.g., the same command) when triggered by a different layer of the VM 106. An example is illustrated at FIG. 4 in accordance with some embodiments. In the depicted example, the trusted layer 230 programs the security control register 105 to store security control information 115 indicating that register programming commands issued by the layer 231 are to be intercepted, and further indicating that register programming commands triggered by the layer 232 are to be permitted.

After the security control information 115 has been stored at the security control register 105, the layer 231 of the VM 106 issues and command, requesting execution of operations 345 to program one or more of the control registers 346. However, based on the security control information 115 at the security control register 105, the secure hardware 110 intercepts the command 343, and in particular prevents execution of the operations 345 so that the control registers 346 are not programmed as indicated by the command 343.

In addition, after the security control information 115 has been stored at the security control register 105, the layer 232 of the VM 106 issues a command 452, requesting execution of operations 453 to program one or more of the control registers 346. In at least some embodiments, the command 343 and the command 452 target (that is, attempt to program) the same ones of the control registers 346. Based on the security control information 115 at the security control register 105, the secure hardware 110 does not intercept the command 343, but instead allows the operations 453 to program the one or more of the control registers 346. Thus, in the example of FIG. 4, the trusted layer 230 is able to control which layers of the VM 106 are permitted to execute particular events. The trusted layer 230 is therefore able to implement any of a variety of security protections for the VM 106, providing the VM 106 with the flexibility to adapt to changing security needs and environments.

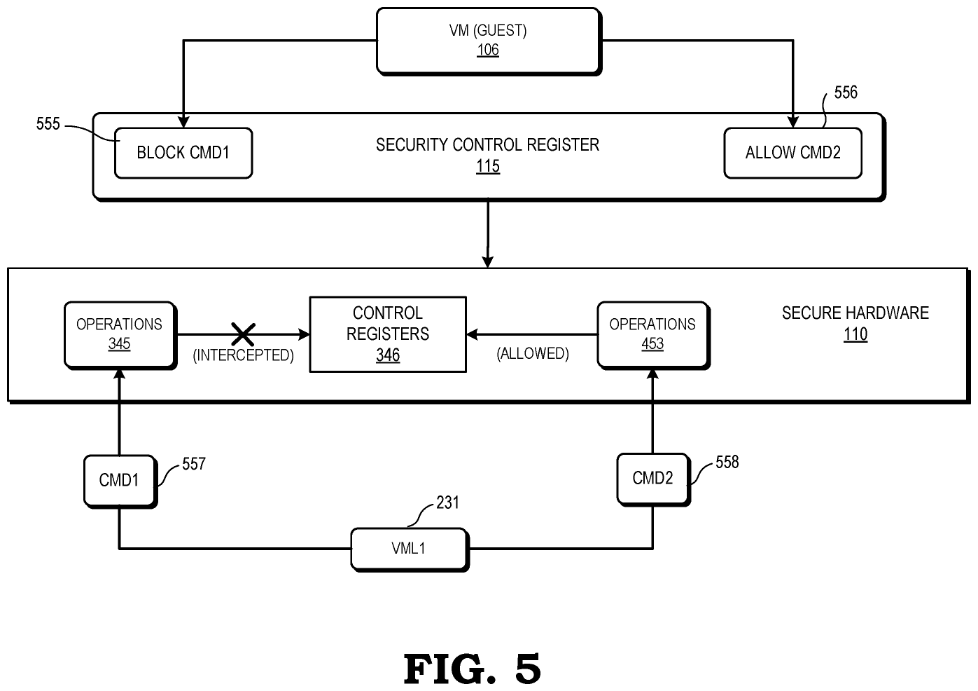

In some embodiments, the trusted layer 230 permits one type of event (e.g., a command to program a particular control register) triggered by a particular layer of the VM 106 and prohibits a different type of event (e.g., a command to program a different control register) when triggered by the same layer of the VM 106. An example is illustrated at FIG. 5 in accordance with some embodiments. In the depicted example, the trusted layer 230 programs the security control register 105 to store security control information 115 indicating that a command to program one control register, designated CMD1, issued by the layer 231 is to be intercepted, and further indicating that a command to program a different control register, designated CMD2, triggered by the layer 231 is to be permitted.

After the security control information 115 has been stored at the security control register 105, the layer 231 of the VM 106 issues a command 557, wherein the command 557 is a CMD1 command. The CMD1 command requests execution of operations 345 to program one of the control registers 346 with a particular value (e.g., a value indicated in an operand of the command 557). However, based on the security control information 115 at the security control register 105, the secure hardware 110 intercepts the command 557, and in particular prevents execution of the operations 345 so that the targeted control register is not programmed.

In addition, after the security control information 115 has been stored at the security control register 105, the layer 231 of the VM 106 issues a command 558, wherein the command 558 is a CMD2 command. The CMD2 command requests execution of operations 453 to program a value to one of the control registers 346 (different than the control register targeted by the command 557). Based on the security control information 115 at the security control register 105, the secure hardware 110 does not intercept the command 558, but instead allows the operations 453 to execute, so that the targeted control register is programmed with the value indicated by the command 558. Thus, in the example of FIG. 5, the trusted layer 230 is able to control which types of commands, and which ones of the control registers 346, are permitted to execute for a particular layer of the VM 106.

It will be appreciated that the embodiments of FIGS. 3-5 are examples only, and that in other embodiments the trusted layer 230 stores control information reflecting different combinations of events and layers of the VM 106 to control which types of events are intercepted for each layer of the VM 106. Thus, for example, in some embodiments the trusted layer 230 sets the security control information 115 so that one set of commands, exceptions, and instructions (or any combination thereof) associated with layer 231 are intercepted by the secure hardware 110, and so that a different set of commands, exceptions, and instructions (or any combination thereof) associated with layer 231 are intercepted.

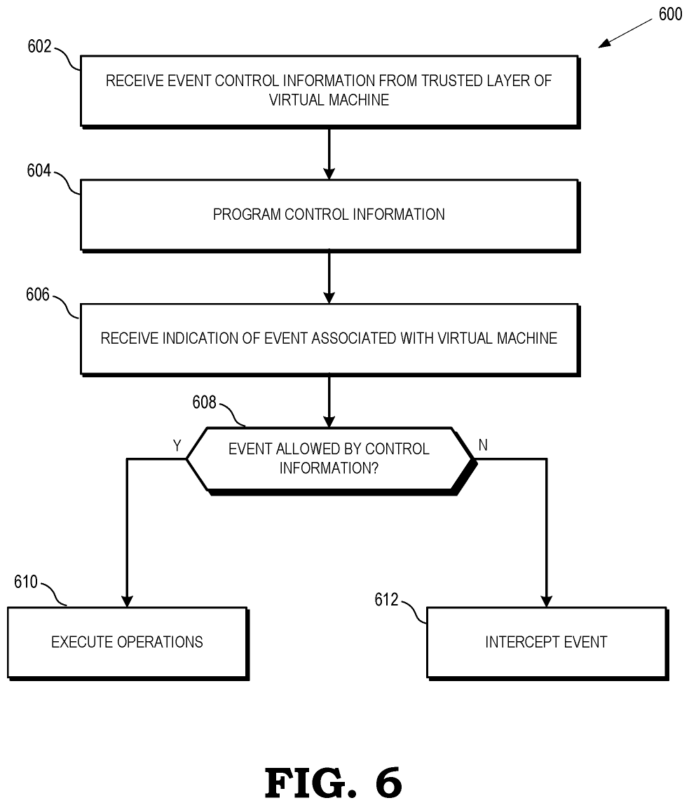

FIG. 6 illustrates a flow diagram of a method 600 of programming security control information to manage interception of events at a processing system in accordance with some embodiments. For purposes of description, the method 600 is described with respect to an example implementation at the processing system 100 of FIG. 1. However, it will be appreciated that in other embodiments the method 600 is implemented in processing systems having different configurations than the processing system 100.

At block 602, the security control register 105 receives the security control information 115 from the trusted layer 230 of the VM 106. In response, at block 604, the security control register 105 is programmed with (that is, stores) the security control information 115. At block 606, the secure hardware 110 receives an indication of an event, such as a command, exception, or instruction, from the VM 106. In response, at block 608, the secure hardware 110 checks the security control information 115, at the security control register 105, to determine if the indicated event is to be intercepted. If not, the method flow moves to block 610 and the secure hardware executes operations requested or triggered by the indicated event. If, at block 608, the secure hardware 110 determines that the event is to be intercepted, the method flow moves to block 612 and the secure hardware 110 intercepts the event. For example, the secure hardware 110 prevents execution of the operations, thereby protecting confidential information associated with the VM 106.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
receiving a first request from a virtual machine to set control information to intercept a first event at a processor; and
in response to detecting the first event, intercep the first event at hardware of the processor, based on the first request.

2. The method of claim 1, wherein:
the virtual machine comprises a plurality of layers including a first layer; and
setting the control information in response to receiving the first request from the first layer.

3. The method of claim 2, wherein the first request comprises a request to intercept the first event associated with a second layer of the plurality of layers of the virtual machine.

4. The method of claim 3, wherein the first layer is associated with a first level of trust and the second layer is associated with a second level of trust, the second level of trust indicating a lower level of security than the first level of trust.

5. The method of claim 4, wherein intercepting the first event comprises intercepting the first event in response to the first event being triggered by the second layer of the virtual machine.

6. The method of claim 5, further comprising:
allowing execution of the first event in response to the first event being triggered by a third layer of the virtual machine.

7. The method of claim 1, wherein the first event comprises a command to modify a register.

8. The method of claim 7, wherein the register stores control information for the processor.

9. The method of claim 1, wherein the first event comprises an instruction.

10. A method, comprising:
setting control information at a processor based on a request received from a first layer of a virtual machine; and
intercepting an event triggered by a second layer of the virtual machine based on the control information.

11. The method of claim 10, wherein the first layer and the second layer of the virtual machine are associated with different levels of trust.

12. A processor comprising:
a control register configured to store control information, received from a virtual machine, to intercept a first event at a processor; and
secure hardware configured to, in response to detecting the first event, intercept the first event at hardware of the processor.

13. The processor of claim 12, wherein:
the virtual machine comprises a plurality of layers including a first layer; and
the control register receives the control information from the first layer.

14. The processor of claim 13, wherein the control information comprises a request to intercept the first event associated with a second layer of the plurality of layers of the virtual machine.

15. The processor of claim 14, wherein the first layer is associated with a first level of trust and the second layer is associated with a second level of trust, the second level of trust indicating a lower level of security than the first level of trust.

16. The processor of claim 15, wherein the secure hardware is configured to intercept the first event in response to the first event being triggered by the second layer of the virtual machine.

17. The processor of claim 16, wherein the secure hardware is configured to:
allow execution of the first event in response to the first event being triggered by a third layer of the virtual machine.

18. The processor of claim 12, wherein the first event comprises a command to modify a second register.

19. The processor of claim 12, wherein the first event comprises an exception.

20. The processor of claim 12, wherein the first event comprises a command to modify a register.
